(19) United States
(12) Patent Application Publication
(10) Pub. No.: US 2022/0112927 A1
(43) Pub. Date: Apr. 14, 2022

(54) BRAKE SYSTEM AND METHOD

(71) Applicant: McIntosh Brake Systems, LLC, Hillside, NJ (US)

(72) Inventor: Peter R. McIntosh, Milford, NJ (US)

(21) Appl. No.: 17/277,040

(22) PCT Filed: Oct. 26, 2020
(86) PCT No.: PCT/US2020/057337

§ 371 Date: Mar. 17, 2021

Related U.S. Application Data
(60) Provisional application No. 62/926,045, filed on Oct. 25, 2019.

(51) Int. Cl. F16D 65/12; B66B 1/36; F16D 1/076

(52) U.S. Cl. CPC F16D 65/123; B66B 11/043; F16D 1/076; B66B 1/365

(57) ABSTRACT

A brake adapter, kit, and method of using therein for attaching a brake to an elevator system. The adapter configured to apply a contact the main machine shaft while integrally applying bearing retention pressure, and transmitting force between a brake and the machine shaft. The adapter replaces the traditional bearing retention cap and is capable of improved installation over previous supplemental brake systems.

### I. REFERENCE TO THE RELATED PATENT APPLICATION

The present application claims benefit of U.S. Provisional Application No. 62/926,045 filed on Oct. 25, 2019, the content of which is incorporated by reference in its entirety.

### II. TECHNICAL FIELD

The present disclosure is in the field of brake systems. In certain embodiments, the present disclosure relates to a supplemental brake for an elevator machine and a method of attaching the system thereto.

### III. BACKGROUND

A “gearless traction machine” or “elevator machine” consists of a motor which drives a main machine shaft and sheave assembly that supports and acts on elevator ropes to move the elevator cab up and down the hoistway. The main machine shaft is a key portion of the elevator machine assembly and acts as the mechanical component for transmitting rotation and torque from an electric motor. As the machine shaft rotates, the sheave rotates, thereby pulling the rope which drives the elevator up or down. For purposes of this application, main machine shaft, elevator machine shaft, motor shaft, rotating element shaft, and machine shaft will be used interchangeably.

FIG. 1 depicts a typical gearless traction machine 100 including drive motor 110, drive sheave 120, primary brake 130 including disc brake drum 140 and internal drum brake 150, a brake side pedestal 160, a bearing pedestal cover 170, and bedplate 180.

Gearless traction machines are typically designed with a main machine shaft 250, drive sheave 210, and brake drum 140 between the bearing journals. Bearings 210 sit in the bearing pedestal 160 or end bell, which support the rotating element. By removing the outer cover of the pedestal 170, access is provided to the end of the main machine shaft 250 and bearings 210. Accessing the machine shaft 250 and bearings 210, however, also may require removing a bearing retention cap which applies bearing retention pressure to the bearings.

The elevator machine motor includes the rotating element including conductors which interact with the magnetic field of the field frame or stator to generate an electromagnetic force that rotates the main machine shaft 250.

The rotating element is supported by bearings 210 through which the machine shaft 250 extends. The bearings 210, however, must be secured (e.g. a bearing retention force) to prevent unwanted radial and axial movement (i.e. movement in the axial direction of main machine shaft 250).

In order to improve the safety of an elevator, elevator operators/owners can install a supplemental brake. This increase in elevator safety can also be reflected in updated building codes which require elevators to increase their level of safety from when the elevator was first constructed, or from the last safety update of the elevator. At the time of an upgrade to the elevator system (“Modernization”) an additional brake for the purpose of Unintended Car Motion (“UCM”) and Ascending Car Overspeed (“ACO”) is often sought out by the owner/operator and can be required by the building codes. This additional brake increases the safety of the elevator system.

The most common method of increasing the safety of the elevator system is by the installation of a device commonly known as a “rope gripper” which applies a braking force directly to the ropes supporting the elevator. As its name implies, a rope gripper clamps the ropes to perform braking. Problems arise with these systems, however, when the physical space to install the rope gripper is limited.

Supplemental brake systems are sometimes sheave-mounted such that the supplemental brake system is attached directly to the machine drive sheave, or to a component that rotates with the sheave.

Depending on the installation location and the construction of the elevator machine, the above system may not be appropriate for, or even capable of installation to the elevator machine because there may not be space to raise the elevator, access the sheave, or mount the new brake.

These supplemental brake systems are typically “power-activated” such that if power at the supplemental brake is ever lost, the supplemental brakes will automatically activate.

### IV. SUMMARY

The above supplemental brake systems require installation between the elevator machine and the elevator cab or counterweight or directly to the machine drive sheave. Due to existing restrictions in space, rope gripper systems may require “raising” the elevator machine, which can be a dangerous, costly, and inefficient. This typically includes structural alterations to the building to accommodate the supplemental brake system itself. In some installations the system is located at the top of the hoistway, which is also undesirable because service and repair become difficult.

Embodiments of the invention overcome the above industry problems by providing a main machine shaft mounted adapter configured to connect the machine shaft to a brake while integrally providing a bearing retention force to retain the motor bearing. This may be particularly suitable for elevator machines where the bearing is mounted at or near the end of the machine shaft and can be installed by utilizing the service access points on existing elevator machines.

Embodiments of the present invention can be used in a system as illustrated in FIG. 1 by removing the bearing pedestal cover 170 which allows access to bearings 210 and machine shaft 250 for service and repairs. After removing pedestal cover 170, an adapter is installed directly onto the main machine shaft 250 that is capable of transmitting torque and applying bearing retention pressure to bearings 210, and then attaching a brake to the end of the adapter.

Moreover, as a gap between the adapter and the machine shaft can cause problems, this system allows for the brake force to be properly transmitted to the main machine shaft by ensuring that the adapter is seated against the shaft with no gap.

Embodiments of the invention may include an elevator brake system comprising an adapter configured to attach a brake to a machine shaft; wherein the adapter is configured to connect to the machine shaft; wherein the adapter is configured to apply a bearing retention force on a bearing to retain the bearing in an axial direction; and wherein the adapter is further configured to connect to the brake.

Embodiments of the invention may further comprise wherein the adapter is configured to seat to an end of the machine shaft.

Embodiments of the invention may further comprise a drive pin to transmit force from between the adapter and the brake.

Embodiments of the invention may further comprise wherein the applied bearing retention force is adjustable.

Embodiments of the invention may further comprise wherein the applied bearing retention force is adjustable via a jacking screw.

Embodiments of the invention may further comprise wherein the adapter further includes a recessed portion to accommodate the machine shaft.

Embodiments of the invention may further comprise wherein the adapter is configured to contact the machine shaft before the jacking screws are adjusted to contact the bearing.

Embodiments of the invention may further comprise a space between the adapter and the bearing between 0.005″ and 0.030″.

Embodiments of the invention may further comprise wherein the adapter is attached to the machine shaft via a bolt.

Embodiments of the invention may further comprise wherein the adapter includes a first end and a second end; wherein the adapter attaches to the machine shaft on the first end and attaches to the brake on the second end; and wherein the first end and second end are on opposite ends of the adapter.

Embodiments of the invention may further comprise wherein the adapter further includes a protruding portion to accommodate the machine shaft.

Embodiments of the invention may further comprise a jacking screw to detach the adapter from the machine shaft.

Embodiments of the invention may comprise a method of adding a brake to an elevator machine shaft comprising the steps of: attaching an adapter to the elevator machine shaft; applying bearing retention pressure from the adapter to a bearing; and attaching a brake to the adapter.

Embodiments of the invention may further comprise wherein when attaching the adapter to the elevator machine shaft, the adapter is seated to an end of the elevator machine shaft.

Embodiments of the invention may further comprise wherein brake force is transmitted from the brake via a drive pin.

Embodiments of the invention may further comprise adjusting the bearing retention pressure.

Embodiments of the invention may further comprise the steps of adjusting the bearing retention pressure via a jacking screw.

Embodiments of the invention may further comprise wherein the adapter further includes a recessed portion.

Embodiments of the invention may comprise an elevator machine comprising: a motor; a sheave; a main machine shaft; a bearing; a brake; an adapter configured to attach to the main machine shaft on a first end, connect to the brake on a second end, and apply bearing retention pressure on the bearing.

Embodiments of the invention may further comprise wherein the first end and second end are located on opposite ends of the adapter in the axial direction.

### V. BREIF DESCRIPTION OF THE DRAWINGS

FIG. 1 illustrates a typical gearless traction machine in the related art.

FIGS. 2A-F depict embodiments of the invention including an adapter 200 from various perspectives.

FIG. 3 illustrates an exploded view of an assembly which depicts how an adapter could be oriented in an embodiment of the invention.

FIGS. 4 and 5 depict how embodiments of the invention may appear in an elevator machine assembly.

FIGS. 6A-C illustrate a cut-out view of an attached main machine shaft mounted brake with different orientations between the main machine shaft and motor bearing.

FIG. 7 illustrates an embodiment of how an adapter of the present invention attaches to a brake.

FIG. 8 illustrates a method of how an embodiment of the supplemental brake system could be used.

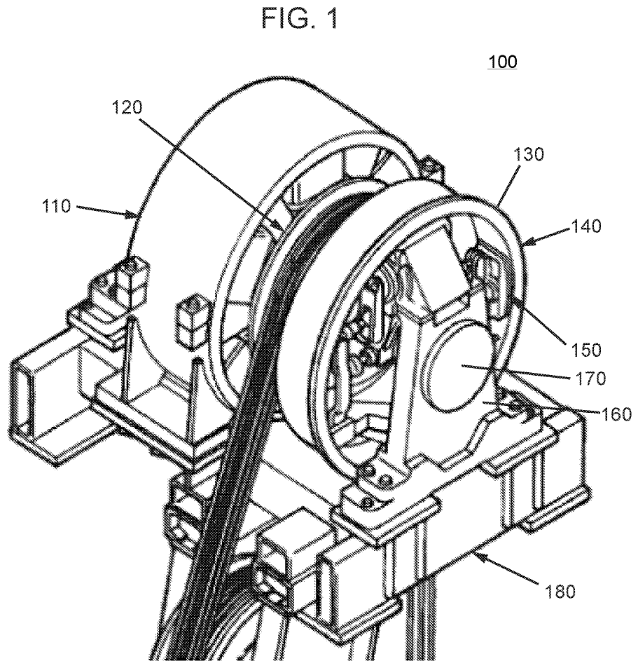

### VI. DETAILED DESCRIPTION

Embodiments disclosed herein provide for a secure and cost-effective system of a brake for an elevator, an elevator system, and a method of attaching a supplemental brake to an elevator machine and may incorporate one or more of the following features.

Embodiments of the invention overcome the above industry problems by providing a main machine shaft-mounted adapter configured to connect the machine shaft to a brake while integrally providing a bearing retention force to retain the motor bearing.

Most bearings 210 are secured onto the main machine shaft 250 with some form of a bearing retention device such as a bearing retention cap. The force applied to the side of the bearing's inner race is important for proper bearing retention.

The adapter must sit flush to the end of the machine shaft 250 and be torqued to specifications different from, and often exceeding, the force required on the bearing 210. If the adapter does not sit flush to the end of the main machine shaft 250, then the structural integrity may be compromised. For example, when torque is applied to the adapter, it transfers that force to connection components (e.g. bolts or pins) which may bend or break, rather than transferring the force onto the machine shaft. Therefore, the adapter seats to the end of the main machine shaft 250 and directly abuts the end of the machine shaft 250.

A secondary adjustment can be made using jacking screws to apply the recommended bearing retention force to the bearing 210. Therefore, when installing the adapter, the adapter is designed to contact the main machine shaft 250 before contacting the bearings 210 to ensure proper shaft attachment and is adjustable to apply the recommended bearing retention force. Because the adapter mounts directly onto the machine shaft 250, and not the bearing 210, there is no risk of excessively high forces being placed on the bearing.

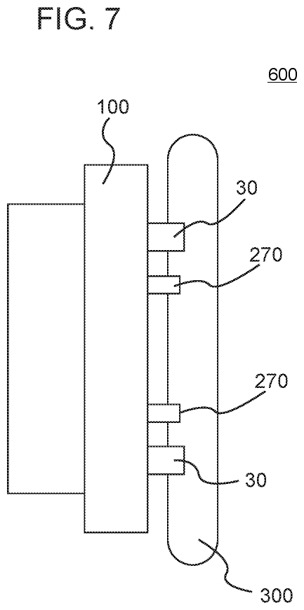

The adapter is engineered for specific applications and precision drilled, reamed, and mounted. The adapter may be mounted with a disc type brake (single or two piece rotor) to the main machine shaft 250, with the use of a single, or multiple caliper[s] to provide braking force. (See for example, FIGS. 4 and 7 and the detailed description thereof.) The adapter provides for mounting of a brake rotor which can be stopped by single or multiple calipers. The adapter could also be used with other brakes such as a plate or clutch type brake.

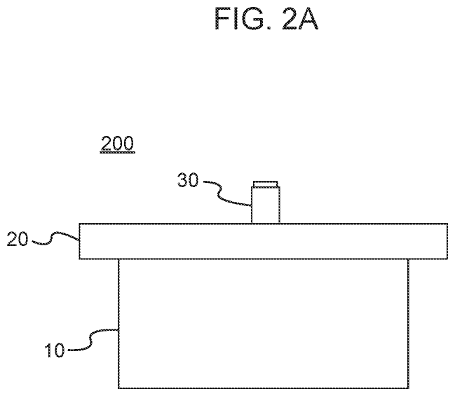

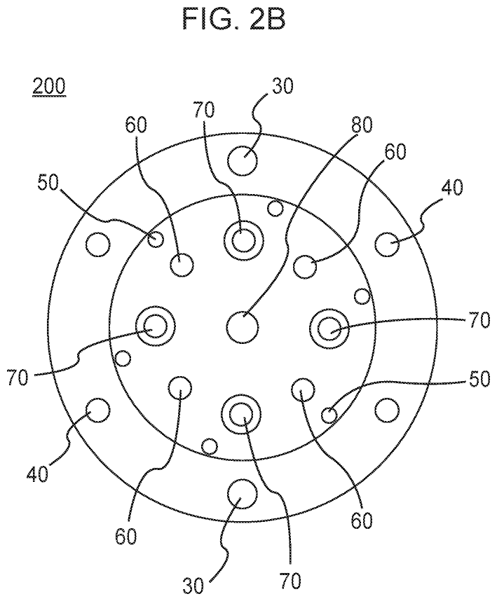

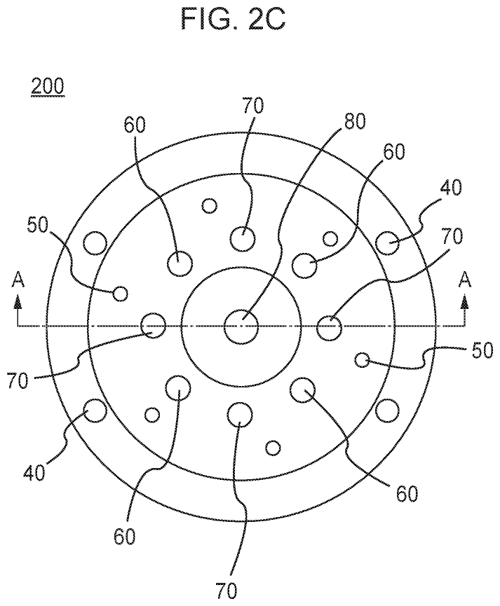

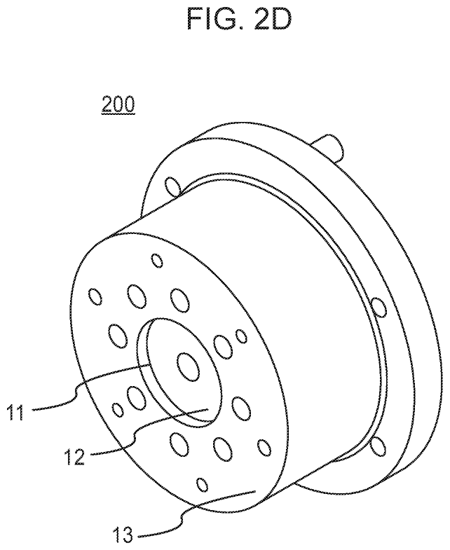

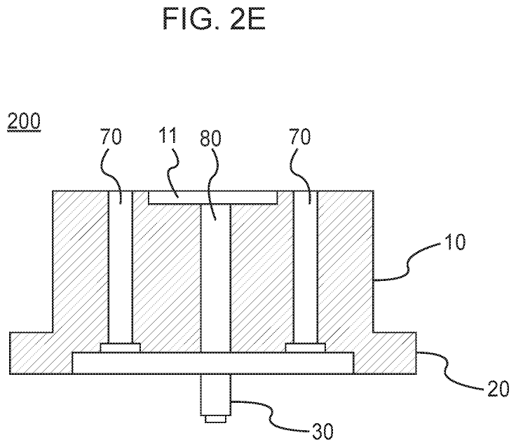

FIGS. 2A-F depict embodiments of the invention including an adapter 200 from various perspectives. The adapter 200 may be mounted to the end of a main machine shaft 250 on one end and a brake assembly on another end.

As depicted in FIG. 2A, the adapter 200 of one embodiment of the invention includes first portion 10 having a first diameter, a second portion 20 having a second diameter, and a dowel pin 30 having a third diameter. In this embodiment, the second portion 20 has the largest diameter while the first portion 10 has the next largest diameter, and the dowel pin 30 the smallest diameter.

The adapter may have multiple drive pins, dowels, or dowels pins 30, and, in some embodiments, the dowel pins 30 may not be included or may be removable from the adapter 200.

As will be discussed below, the various holes for mounting the adapter 200 and adjusting the adapter 200 may depend on the elevator machine system configuration.

In certain embodiments the first portion 10 will have a diameter of approximately 4 inches-9 inches, the second portion 20 will have a diameter of approximately 6 inches-13 inches, and the dowel pins 30 will have a diameter of approximate 0.375 inches-0.875 inches.

The first portion 10 and second portion 20 may be manufactured from various materials such as carbon steel 4140.

FIG. 2B illustrates a brake-facing perspective of an embodiment of the invention including adapter 200. In certain embodiments, the brake facing side is located on the opposite end of adapter 200 as the main machine shaft facing side. FIG. 2B provides a detailed view of the top surface of second portion 20 which may include dowel pins 30. As discussed previously, these dowel pins 30 may be permanently or removably attached to the second portion 20.

From these perspectives, features of the adapter 200 can be seen located at various distances from the center of second portion 20. These figures are intended to be exemplary and other orientation, size, and number of the features discussed below may be utilized depending on the design requirements. These figures can also be understood to be drawn proportionally, but are not limited to only proportional representations.

In the outer most diameter of the top surface of second portion 20, two dowel pins 30 and four holes 40 are shown. The holes 40 may be threaded and are used to mount a brake to the adapter 200 with fasteners such as bolts or screws. The dowel pins 30 transmit force between the adapter 200 and a brake. For example, in the case of a disc brake, the dowel pins 30 may be inserted into holes in the disc portion of the brake such that the adapter 200 and brake are rotationally connected. (An example is shown in FIG. 7.).

The number and positioning of the holes 40 and dowel pins 30 could be different depending on the system requirements, and the layout and configuration shown in FIG. 2B is shown only as an example.

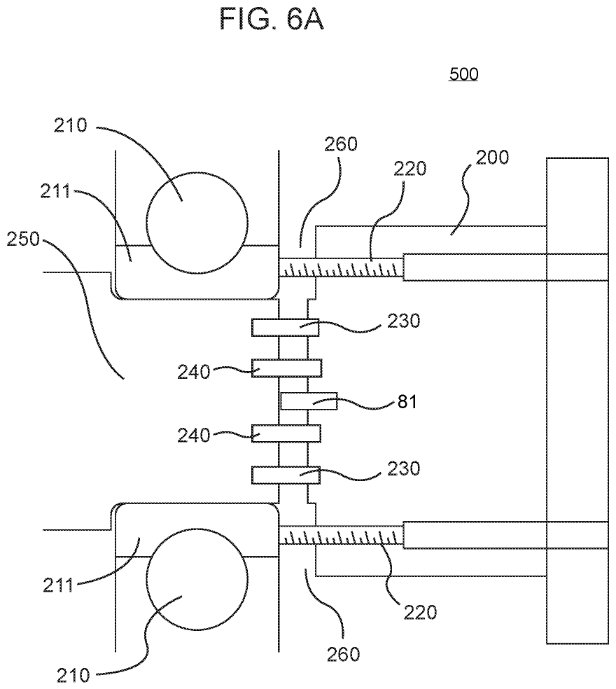

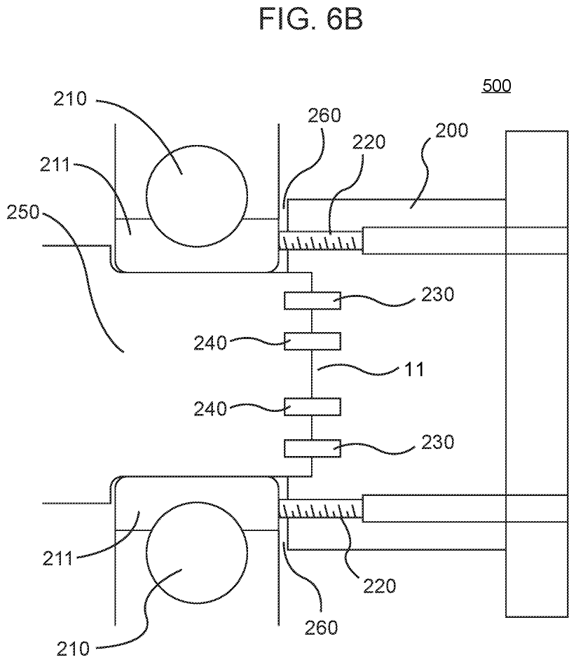

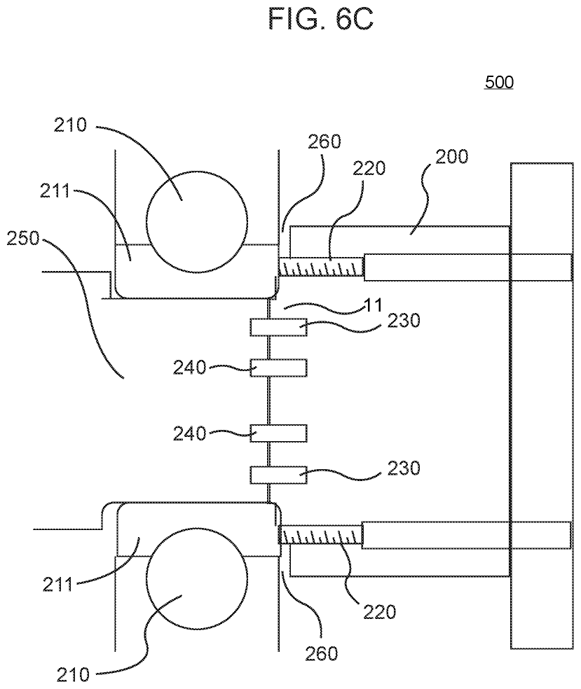

In the next largest diameter, six clearance holes 50 are depicted. These holes may be threaded and the bottom and are used for bearing retention with jacking screws 220. By using the adapter 200 to retain the bearing 210, the original bearing retainer cap is no longer necessary. More specifically, jacking screws 220 may be inserted into the clearance holes 50 until they contact the bearing 210 at bearing inner race 211which hold the bearing balls in place. (An example is shown in FIGS. 6a-c.) Then, the jacking screws 220 are adjusted (e.g., tightened) until proper bearing retention pressure is applied.

The necessary torque depends on the systems configuration and components. This is typically defined by the bearing specifications. For example, the torque range may be 60-300 pound-feet (1b-ft).

The bearing retention pressure is applied to the inner race 211 of the bearing 210 and serves several of purposes. First, it prevents the bearing 210 from being pushed out of the elevator machine in an axial direction. For example, as the main machine shaft 250 rotates, it may push the bearing 210 outward from the motor. Second, if the main machine shaft 250 causes the inner race 211 of the bearing 210 to spin too much, it may cause wear and other damage to the bearing 210 or main machine shaft 250.

In certain scenarios the bearing 210 may overhang or be recessed from the main machine shaft 250. This can cause a gap between the bearings 210 and the component providing the bearing retention force or the adapter 200 and the end of the main machine shaft 250. This can result in improper axial force on the bearing 210 or unseated adapter.

An embodiment of the present invention overcomes this problem by securing the adapter 200 to the main machine shaft 250, and independently applying the bearing retention force from the adapter to the bearing 210. In other words, by using the jacking screws 220 to apply pressure to the bearing 210, the bearing 210 can be retained while the adapter 200 sits flush with the main machine shaft 250.

Depending on the positional relationship between the bearing 210 and the machine shaft 250, the adjustment to the jacking screws 220 will be larger or smaller. For example, if the bottom surface of bearing 210 is flush with the top surface of the main machine shaft 250, then limited adjustments to the jacking screws 220 will be necessary to apply proper bearing retention force because the jacking screws 220 will not have to extend far beyond the adapter 200 in order to contact the bearings 210.

Conversely, if the bearing 210 is located inboard of the machine shaft 250 (e.g. not extending as far as the machine shaft 250 in the axial direction), then the jacking screws will need to be positioned past the machine shaft 250.

It is also desirable to limit the extension of the jacking screws 220 from the adapter 200 to the bearings 210. This gap 260 may be limited to five thousandths (0.005″) to 30 thousandths (0.030″) of an inch gap or length between the adapter 200 and the end of the jacking screw 220. (An example gap is illustrated in FIGS. 6A-C). Depending on the distance between the adapter 200 and the bearing 210, shims such as washers placed on the bearing 210 may also be used.

If, on the other hand, the bearing 210 overhangs the machine shaft 250, then the jacking screws 220 will be recessed from the end of the machine shaft 250.

Alternatively, as will be discussed, for example, with regard to FIG. 2D, the adapter 200 may include recessed or protruding portions 11 which account for the distance between the bearings 210 and the main machine shaft 250.

In the next largest diameter, two sets of holes are depicted. First, four through holes 60 are depicted. Through holes 60 may be used to attach the adapter 200 to the machine shaft 250 and may extend through the bottom of first portion 10 of the adapter 200.

Pins or drive pins 240 may be inserted through the through holes 60 in order to transmit rotational torque between the adapter 200 and machine shaft 250. The holes in the main machine shaft 250 for the drive pins 240 inserted in the through holes 60 are the same size as, or slightly smaller than the drive pins 240 themselves. (See example in FIGS. 6A-C). Thus, the drive pins 240 fit tightly (e.g. a press fit) into the through holes 60 and are able to transfer torque between the adapter 200 and the main machine shaft 250. These holes 60 may be used as pilot holes to drill into the main machine shaft 250, when installing the adapter 200. In certain embodiments, a reamer is used to open the hole and then the pins 240 are inserted to transmit energy between the main machine shaft 250 and the adapter 200.

Second, four countersunk holes 70 are shown. Bolts 230 may be inserted into countersunk holes 70 to retain the adapter to the main machine shaft 250 as well as transmit torque. (See example in FIGS. 6a-c). These holes 70 may be used as pilot holes to drill and tap into the main machine shaft 250, when installing the adapter.

The holes in the machine shaft that accommodate the bolts 230 which are inserted through holes 70 are slightly larger than the bolts 230, but likely include threads that the bolts 230 can be tightened into. (See example in FIGS. 6A-C).

To install the adapter 200 with drive pins 240 the same size or slightly larger than the holes in the main machine shaft 250 (i.e. press fit), the drive pins 240 are aligned with the holes and then the bolts 230 are tightening thereby bringing the adapter 200 closer to the main machine shaft 250 until the drive pins 240 are inserted to a desired distance.

In the center of second portion 20, a jacking hole 80 is depicted. A jacking screw 81 via jacking hole 80 is used to remove the adapter 200 for machine service, when necessary. (See example in FIG. 6A). For example, in order to service or replace the bearing 210 or main machine shaft 250, the brake unit will first have to be removed. The adapter 200 will then have to be removed. This will expose the bearing 210 and the main machine shaft 250 for standard bearing replacement procedures.

In order to remove the adapter 200 from the main machine shaft 250 for maintenance or other requirements, the bolts 230 are first removed. Though the bolts 230 are removed, the drive pins 240 remain press fit into main machine shaft 250. Accordingly, the jacking screw 81 through hole 80 is tightened (i.e. pushed into the main machine shaft 250) thereby pushing adapter 200 away from main machine shaft 250, until the drive pins 240 are extricated.

FIG. 2C illustrates a main machine shaft facing view of an embodiment of the invention.

As shown in FIG. 2D, this embodiment may also include different depths and/or surfaces and the main machine shaft 250 side of adapter 200. In this example, surfaces 12 and 13 are depicted.

These surfaces, as well as the surfaces on the first portion 10 can be adjusted to fit the system. For example, if the main machine shaft 250 overhangs bearing 210, a carve out or recessed portion 11 may be made such that the first portion 10 is still able to seat on the main machine shaft 250 thereby allowing force to be transferred between the adapter 200 and the machine shaft 250 and not onto the bearing 210.

Otherwise stated, if the main machine shaft 250 overhangs bearings 210, the adapter 200 can include a recessed portion 11 which accommodates the overhanging main machine shaft 250 so that the adapter 200 can seat flush with the main machine shaft 250 and apply bearing retention pressure on the bearings 210.

This recessed portion 11 may be manufactured by removing material from the originally manufactured adapter 200 or during the original manufacturing of adapter 200.

FIG. 2E depicts a cross sectional view of the adapter 200 taken along the line A-A as shown in FIG. 2C. From this perspective, the orientation of first portion 10, second portion 20, and dowel pins 30 can be seen in view of counter sunk holes 70, jacking hole 80, and recessed portion 11.

FIG. 2F depicts the end of adapter 200 which faces the braking component such a disc brake 300 to be discussed below. From this perspective, it can be seen that many of the components/holes discussed above may extend through adapter 200. This allows for components which extend within these holes, such as jacking screws 220 to be adjusted after adapter 200 is mounted onto main machine shaft 250.

Additionally, from this perspective, it can be seen that the brake facing side of adapter 200 may include recessed or protruding portions 14 in order to accommodate connections to a brake. In this case, dowel pins 30, which transmit torque between the brake and adapter 200, and holes 40, through which bolts 270 secure adapter 200 to the brake (see FIG. 7), are located on a protruding portion 14 to mount to a brake (e.g. a disc brake). As discussed above, this configuration may be changed in order to accommodate both the size and type of brake.

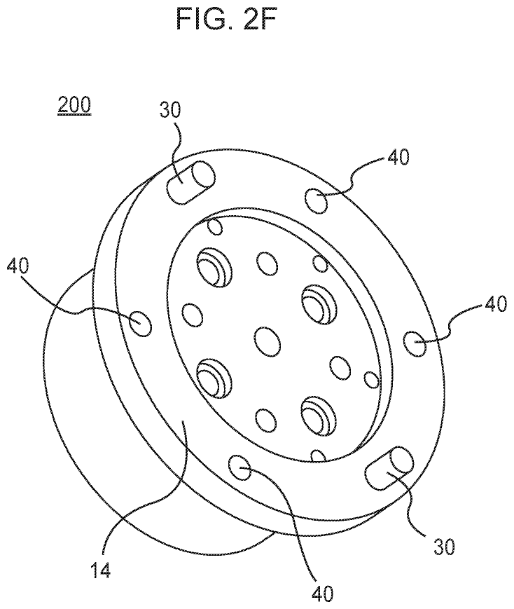

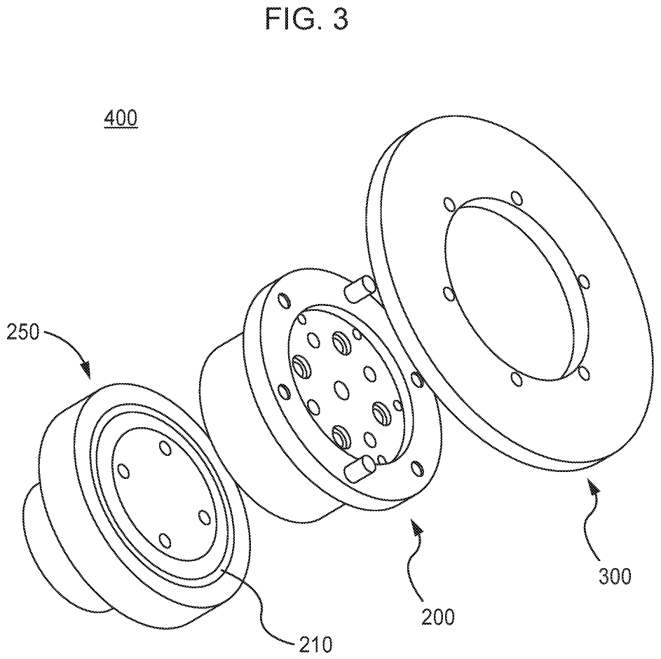

FIG. 3 illustrates assembly 400 which depicts how adapter 200 could be oriented in an embodiment of the invention. As shown, adapter 200 is located between the end of the main machine shaft 250 and bearing 210 and the brake 300. The adapter 200 connects to the brake 300 by use of bolts 270 through holes 40 in the adapter, and dowel pins 30 to transmit the rotational torque.

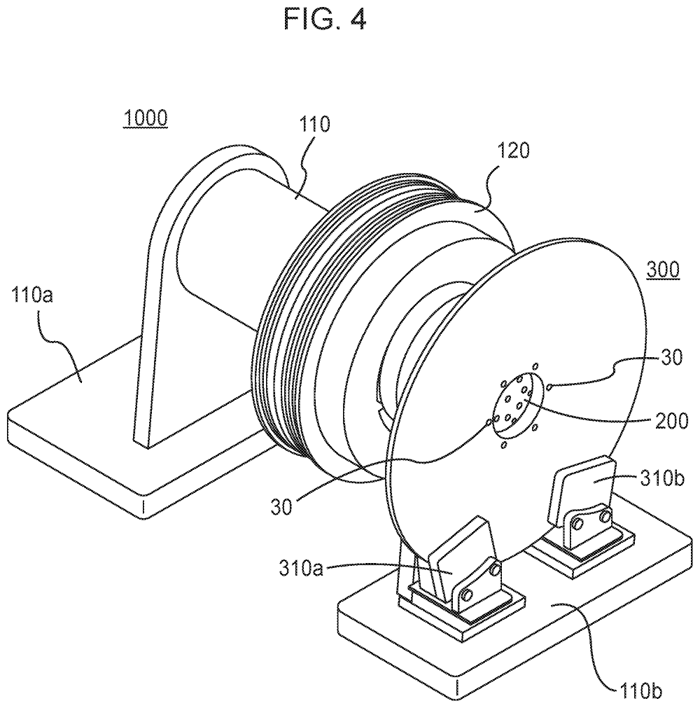

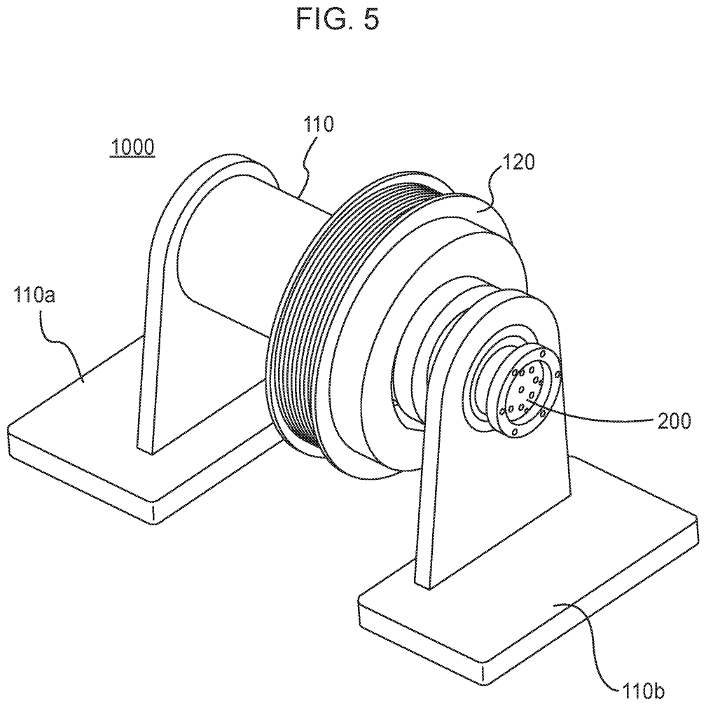

FIGS. 4 and 5 depict how embodiments of the invention may appear in an elevator system 1000. In these figures, a primary brake is not depicted though embodiments of the present invention may also act as a primary brake.

In FIG. 4, adapter 200 is located between main machine shaft 250 and brake disk 300. In this figure, brake disk 300 is located between calipers 310a and 310b which may be used to apply braking force. FIG. 4 also includes pedestals 110a and 110b which may be used to mount the assembly onto the elevator system or onto the building structure.

FIG. 5 is similar to FIG. 4, except that brake disk 300 and calipers 310a and 310b have been removed.

The above embodiments may also be comprised as part of a brake system kit such as a supplemental brake kit for Modernization. The kit including the components depicted in FIG. 4 including, for example, the hardware for mounting the adapter to the machine shaft and brake, a brake, and modified pedestal cap with a seal.

The modified pedestal cap replaces the original pedestal cap and further comprises a seal to retain bearing lubricant because the addition of the adapter to apply the bearing retention pressure, instead of the bearing retainer cap which typically includes a feature to retain bearing lubricant, must prevent the lubricant from escaping.

FIGS. 6A-C illustrate a cut away view of an adapter 200 mounted onto a main machine shaft 250.

In FIG. 6A, main machine shaft 250 extends to approximately the same distance as bearings 210 in the axial direction so that main machine shaft 250 and bearings 210, which include inner race 211, are approximately flush.

Jacking screws 220 extend from adapter 200 to apply bearing retention force on inner race 211 while bolts 230 and drive pins 240 structurally connect adapter 200 and machine shaft 250.

FIG. 6A also illustrates gap 260 which reflects the extension of the jacking screws 220 from the adapter 200 to the bearing 210. As discussed above, in order to maintain structural integrity, the adapter 200 is configured to limit gap 260 to a certain range. In this figure, however, bolts 230 are not finally tightened so adapter 200 is not yet completely attached to (and/or in the process of detaching from) machine shaft 250. Accordingly, as will be discussed with regard to FIGS. 6B and 6C, the adapter 200 will be designed such that gap 260 is within this range by changing the design of adapter 200 (or as discussed above by providing shims on the surface of bearing 210).

In FIG. 6B, main machine shaft 250 extends beyond bearings 210 in the axial direction. Accordingly, in order to apply appropriate bearing retention pressure to bearings 210 while limiting the extension of j acking screws 220, adapter 200 includes a recessed portion 11.

As discussed above, in order to install the adapter 200, bolts 230 are tightened which forces the drive pins 240 in the accommodating holes in the main machine shaft 250 until they reach a desired distance.

In FIG. 6C, bearings 210 extend beyond main machine shaft 250 in the axial direction. Accordingly, in order to apply appropriate bearing retention pressure to bearings 210 while limiting the extension of jacking screws 220, adapter 200 includes a protruding portion 11.

FIG. 7 illustrates an embodiment of how adapter 200 attaches to a brake such as disc brake 300 in assembly 600. As depicted, dowel pins 30 and bolts 270 are inserted in holes in disc brake 300. Accordingly, as brake force is applied to disc brake 300 (e.g. via calipers tightening) torque can be transmitted to adapter 200 via dowel pins 30.

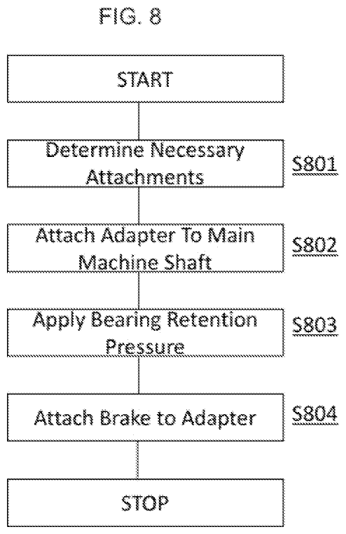

In one embodiment, the invention includes a method of adding a brake to an elevator machine. This method could be accomplished, for example, using the above discussed embodiments. FIG. 8 illustrates a method of how an embodiment of the supplemental brake system could be used. Depending on the system orientation, certain of these steps may or may not be required.

In Step 801, the necessary attachments for connecting an adapter to a main machine shaft and the necessary bearing retention pressure to be placed on the motor bearing needs to be determined. For example, as discussed above, the orientation of the holes in the adapter through which bolts and/or drive pins are inserted as well as the diameter, threading, and thickness of those components may differ depending on the type and size of the main machine shaft and bearing.

In step 802, an adapter which attaches to the main machine shaft as well as a brake and integrally applies a bearing retention pressure is attached to the main machine shaft. This connection could include, for example, bolts, screws, or other fasteners. As noted above, holes in the machine shaft may need to be drilled and/or reamed in order to accommodate bolts and drive pins.

To attach the adapter, drive pins and bolts are inserted through the adapter and aligned with the corresponding holes on the main machine shaft. Then, the bolts are tightened until the drive pins are sufficiently inserted into the machine shaft. This distance could be based on making sure the gap between the adapter and the beating is within a specific distance. For example, the gap could be limited to 0.005″ to 0.030″.

In certain embodiment, the adapter may need to be seated (e.g. contacting) the end of the main machine shaft.

In step 803, bearing retention pressure from the adapter is applied to the motor bearings. The pressure is applied to the bearing race and can be accomplished, for example, using jacking screws as discussed above and can include multiple adjustments until proper pressure is achieved.

In certain embodiments, if there is a large distance between the adapter and the bearings, shims such as a washer can be placed on the bearings before bearing retention pressure is applied in order to limit the distance the jacking screws are extended.

In step 804, a brake is attached to the adapter to transmit torque from the brake to the machine shaft. the brake may be attached using bolts, screws, dowel pins, and/or other fasteners depending on the type of brake. For example, in the case of a disc brake, bolts may be used to secure the adapter to the brake and dowel pins may be used to transmit force from the brake to the adapter.

The invention claimed is:

1. A supplemental elevator brake system comprising:
an adapter configured to attach a brake to a machine shaft;
wherein the adapter is configured to connect to the machine shaft;
wherein the adapter is configured to apply a bearing retention force directly onto a bearing to retain the bearing in an axial direction; and
wherein the adapter is further configured to connect to the brake.

2. The supplemental elevator brake system of claim 1,
wherein the adapter is configured to seat to an end of the machine shaft.

3. The supplemental elevator brake system of claim 1, further comprising:
a drive pin to transmit force from between the adapter and the brake.

4. The supplemental elevator brake system of claim 1,
wherein the applied bearing retention force is adjustable.

5. The supplemental elevator brake system of claim 4,
wherein the applied bearing retention force is adjustable via a jacking screw.

6. The supplemental elevator brake system of claim 1,
wherein the adapter further includes a recessed portion configured to accommodate the machine shaft.

7. The supplemental elevator brake system of claim 5,
wherein the adapter is configured to contact the machine shaft before the jacking screw is adjusted to contact the bearing.

8. The supplemental elevator brake system of claim 1,
wherein there is a distance between the adapter and the bearing between 0.005″ and 0.030″.

9. The supplemental elevator brake system of claim 1,
wherein the adapter is attached to the machine shaft via a bolt.

10. The supplemental elevator brake system of claim 1,
wherein the adapter includes a first end and a second end;
wherein the adapter attaches to the machine shaft on the first end and attaches to the brake on the second end; and
wherein the first end and second end are on opposite sides of the adapter.

11. The supplemental elevator brake system of claim 1,
wherein the adapter further includes a protruding portion configured to accommodate the machine shaft.

12. The supplemental elevator brake system of claim 1,
further comprising a jacking screw to detach the adapter from the machine shaft.

13. A method of adding a supplemental brake to an elevator machine shaft comprising:
attaching an adapter to the elevator machine shaft;
applying bearing retention pressure from the adapter directly onto a bearing; and
attaching a brake to the adapter.

14. The method of claim 13,
wherein when attaching the adapter to the elevator machine shaft, the adapter is seated to an end of the elevator machine shaft.

15. The method of claim 13,
wherein brake force is transmitted from the brake via a drive pin.

16. The method of claim 13, further comprising adjusting the bearing retention pressure.

17. The method of claim 16, further comprising adjusting the bearing retention pressure via a jacking screw.

18. The method of claim 11, further comprising
accommodating the machine shaft.

19. An elevator machine comprising:
a motor;
a sheave;
a main machine shaft;
a bearing;
a brake;
an adapter configured to attach to the main machine shaft on a first end, connect to the brake on a second end, and apply bearing retention pressure directly onto the bearing.

20. The elevator machine of claim 19, wherein the first end and second end are located on opposite ends of the adapter in an axial direction of the adapter.
